(19) United States
(12) Patent Application Publication
(10) Pub. No.: US 2005/0190446 A1
(43) Pub. Date: Sep. 1, 2005

(54) Catadioptric reduction objective

(75) Inventors: Birgit Kuerz, Aalen (DE); Olaf Dittmann, Bopfingen (DE); Toralf Gruner, Aalen-Hofen (DE); Vladimir Kamenov, Oberkochen (DE); Martin Brunotte, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS AMT AG

(21) Appl. No.: 11/019,202

(22) Filed: Dec. 23, 2004

Related U.S. Application Data
(63) Continuation of application No. PCT/EP03/06680, filed on Jun. 25, 2003.

(30) Foreign Application Priority Data
Jun. 25, 2002 (DE) 102 29 614.6

(51) Int. Cl. G02B 17/00

(52) U.S. Cl. 359/496; 359/487

(57) ABSTRACT

A catadioptric projection objective for projecting a pattern, which is located in the object plane of the projection objective, into the image plane of the projection objective has, between the object plane and the image plane, a catadioptric objective part provided with a concave mirror (17), with a first deviating mirror (16) and with at least one second deviating mirror (19). A polarization rotating device (26) rotates the preferred polarization direction of the light approximately 90° inside the light path between the deviating mirrors. This permits an at least partial compensation for polarization-dependent reflectivity differences and phase effect differences of the deviating mirrors thereby enabling a projection with a largely identical contrast for all structural directions.

This application is a continuation application of international patent application PCT/EP2003/006680 filed on Jun. 25, 2003, published under PCT Article 21(2) in German, and claiming priority of German patent application 102 29 614.6 filed on Jun. 25, 2002. Benefit is claimed from German patent application 102 29 614.6 filed on Jun. 25, 2002.

### BACKGROUND OF THE INVENTION

1. Field of the Invention

The invention relates to a catadioptric projection objective for imaging a pattern arranged in an object plane of the projection objective into an image plane of the projection objective.

2. Description of the Related Art

Such projection objectives are used in projection exposure machines for fabricating semiconductor components and other finely structured devices, in particular in wafer scanners and wafer steppers. They serve for projecting patterns of photomasks or lined plates, also referred to below as masks or reticles, onto an article coated with a light-sensitive layer with very high resolution on a demagnifying scale.

In order to produce ever finer structures, it is necessary in this case on the one hand to enlarge the image-side numerical aperture (NA) of the projection objective, and on the other hand to use ever shorter wavelengths, preferably ultraviolet light having wavelengths of less than approximately 260 nm.

Only a few sufficiently transparent materials are still available in this wavelength range for producing the optical components, in particular synthetic silica glass and fluoride crystals, such as calcium fluoride. The Abbe constants of the materials available are relatively close together, and so it is difficult to provide purely refractive systems with adequate correction of chromatic aberrations. Consequently, use is predominantly being made of catadioptric systems for very high resolution projection objectives, refractive and reflecting components, that is to say lenses and mirrors, in particular, being combined in such systems.

Given the use of imaging mirror surfaces, it is necessary to employ beam deflection devices if the aim is to achieve imaging free from obscuration and vignetting. Both systems with geometrical beam splitting by means of one or more fully reflecting deflecting mirrors, and systems with physical beam splitters, in particular those with reflecting surfaces with a polarization-selective action are known. In addition to the functionally necessary reflecting surfaces present, plane mirrors for folding the beam path can be provided in order, for example, to fulfill installation space requirements and to align object and image planes parallel to one another.

Axial (on-axis) systems can be implemented when use is made of a physical beam splitter. Use is made here predominantly of reflecting surfaces with a polarization-selective action that act in a reflecting or transmitting fashion depending on the preferred polarization direction of the incident radiation. Such systems require in the light path between a first and a second use of the beam splitter surface a device for rotating the preferred polarization direction of the light by 90° overall. It is normal to make use for this purpose of quarter wavelength plates traversed twice between the beam splitter and concave mirror. It is the disadvantage of such systems that suitable transparent materials for the beam splitter block in the large volumes required are available only to a limited extent, and that the production of sufficiently effective beam splitter layers can cause substantial difficulties for the given angular load.

Disadvantages of systems with a beam splitter block can be avoided in systems with geometric beam splitting. However, these systems have the fundamental disadvantage that they are extra-axial (off-axis) systems, that is to say systems with an extra-axial object field.

Systems of these type have a first deflecting mirror that is tilted with reference to the optical axis and serves the purpose either of deflecting to the concave mirror the radiation coming from the object plane, or of deflecting to downstream objective parts the radiation reflected from the concave mirror. Provided as a rule is a second deflecting mirror that serves as folding mirror in order to parallelize object plane and image plane. In order to ensure a high reflectivity of these mirrors, they are normally coated with reflective layers, mostly dielectric multiple layers or a combination of metallic and dielectric layers. The light passing through can be influenced as a function of polarization by dielectric layers that are operated at a high angle of incidence.

It has been observed that under certain imaging conditions in catadioptric systems various structural directions included in the pattern to be imaged are imaged with a different contrast. These contrast differences for various structural directions are also denoted as H-V differences (horizontal-vertical differences) or as variations in the critical dimensions (CD variations), and are to be seen in the photoresist as different line widths for the various structural directions.

Various proposals have been made for avoiding such directionally dependent contrast differences. EP 964 282 A2 is concerned with the problem that when light is passing through in catadioptric projection systems with deflecting mirrors a preferred polarization direction is introduced as a result of the fact that the multiply coated deflecting mirrors have different reflection factors for s- and p-polarized light. Consequently, light that is still unpolarized in the reticle plane is partially polarized in the image plane, and this is intended to lead to a directional dependence of the imaging properties. This effect is counteracted by virtue of the fact that, in the illumination system, producing partially polarized light with a prescribed residual degree of polarization results in a polarization offset that is compensated by the projection optics such that unpolarized light emerges at its output.

EP 0 602 923 B1 (corresponding to U.S. Pat. No. 5,715,084) discloses a catadioptric projection objective that operates with linearly polarized light and has a polarization beam splitter in which a device for changing the state of polarization of the light passing through is provided between the beam splitter cube and the image plane in order to convert the incident, linearly polarized light into circularly polarized light (as an equivalent to unpolarized light). The aim of this is to ensure an imaging contrast independent of the structural direction. A corresponding proposal is also made in EP 0 608 572 (corresponding to U.S. Pat. No. 5,537,260).

### SUMMARY OF THE INVENTION

It is one object of the invention to provide a catadioptric projection objective that permits imaging substantially without contrast differences dependent on structural direction for various structural directions of a pattern.

As a solution to this and other objects, this invention, according to one formulation of the invention, provides a catadioptric projection objective for projecting a pattern arranged in an object plane of the projection objective into the image plane of the projection objective, wherein there are arranged between the object plane and the image plane a catadioptric objective part with a concave mirror and a fully reflecting first deflecting mirror, as well as at least a second fully reflecting deflecting mirror, and wherein a polarization rotator for rotating a preferred polarization direction of light passing through is arranged between the first deflecting mirror and the second deflecting mirror in order to compensate polarization-dependent differences in at least one of reflectivity and phase of the deflecting mirrors.

Advantageous developments are specified in the dependent claims. The wording of all claims is included in the description by reference.

A catadioptric projection objective in accordance with one aspect of the invention has between the object plane and the image plane a catadioptric objective part with a concave mirror and a first fully reflecting deflecting mirror, as well as at least a second fully reflecting deflecting mirror. The substantially opaque deflecting mirrors are preferably tilted about parallel tilt axes with reference to the optical axis of the projection objective and are arranged such that object plane and image plane are aligned in parallel. A polarization rotator for rotating a preferred polarization direction of light passing through is arranged between the first deflecting mirror and the second deflecting mirror. The effect of said polarization rotator is designed such that polarization-dependent differences in the effect of reflectivity and phase of the deflecting mirrors are compensated at least partially. The polarization rotator can be used to operate the deflecting mirrors such that, given high overall reflectivity, the overall result is that the mutually vertically oscillating field components of the electric field vector experience a vanishing or only very slight splitting of the amplitude and phase profiles. The polarization rotator is to be designed such that a polarization-splitting effect of the first deflecting mirror, caused by dielectric multilayer reflective coatings, for example, is compensated by the corresponding effect of the second deflecting mirror to such an extent that a possibly still present residual splitting of the directions of polarization lies below a harmless threshold after the second reflection.

In the case of conventional, highly reflecting multilayer coatings, it is known that the fraction of the incident light reflects with a higher reflection factor for which the electric field vector oscillates perpendicular to the plane of incidence (s-polarization). The reflection factor for p-polarized light, for which the electric field vector oscillates parallel to the plane of incidence, is, by contrast, smaller over the entire range of angle of incidence and reaches its minimum at the layer-specific Brewster angle. Consequently, large amplitude splits occur, particularly in the region about the Brewster angle. Moreover, phase differences occur between the various directions of polarization. If, for example, circularly polarized light falls onto such a conventional, obliquely positioned deflecting mirror, the p-component is more strongly attenuated than the s-component after the reflection. If a rotation of the preferred polarization directions then takes place in the light path between the first and second deflecting mirrors, for example by approximately 90°, the second deflecting mirror is irradiated with light for which the s-polarized (with reference to the second deflecting mirror) component, which corresponds to the p-polarized component after first reflection, has a smaller amplitude than the p-component. Given conventional coating, the second deflecting mirror will again reflect the p-component more weakly than the s-component, and so it is possible as a result to achieve a far reaching compensation of the differences of the reflected amplitudes for s- and p-polarizations. A compensation effect also results for the phase differences built up at the first deflecting mirror. The polarization rotator is therefore preferably designed for rotating the preferred polarization direction by approximately 90° between the deflecting mirrors.

The specific rotation of the polarization between the first and second deflecting mirrors permits the use for the deflecting mirrors of conventional highly reflecting reflective coatings that are constructed and can be produced relatively simply.

For projection objectives that have a region traversed twice by the light between the first deflecting mirror and the second deflecting mirror, the polarization rotator can be a retardation device that is arranged in the region traversed twice and has the effect of a quarter wavelength plate, thus enabling linearly polarized light to be converted into circularly polarized light, and vice versa. The polarization rotator can be formed, for example, by a λ/4 plate that is mounted between a geometric beam splitter and the concave mirror, and is transirradiated both in the light path between the first deflecting mirror and concave mirror, and in the light path between the concave mirror and second deflecting mirror.

The retardation device is preferably mounted at a position at which the divergence of the beams passing through is minimal, since the effect of conventional retardation elements is strongly dependent on angle. Particularly favorable is an arrangement in the near zone of a pupil of the projection objective. Since an exact compensation of the said amplitude and phase effects is generally not required, it is possible in many cases to accept tolerances in the region of ±10 to 20% about the exact retardation effect.

It is also possible for the polarization rotator to comprise a λ/2 retardation element that is arranged in a region, traversed only once by the light, between the first deflecting mirror and second deflecting mirror. For systems having a geometric beam splitter and in which the first deflecting mirror serves for deflecting object light in a direction of the concave mirror, and a second deflecting mirror serves for deflecting light coming from the concave mirror in the direction of the image plane, a λ/2 plate or an element of corresponding effect can be arranged nearby behind the first deflecting mirror or nearby in front of the second deflecting mirror in a region where the beam bundles do not overlap.

Polarization rotators with the (approximate) effect of a λ/2 plate or the like can also be useful in projection objectives in the case of which the object light firstly strikes the concave mirror without deflection, and the light reflected therefrom is deflected with the aid of two consecutive deflecting mirrors between which the polarization rotator is to be arranged. Such systems are shown, for example, in U.S. Pat. No. 6,157,498 or EP 0 964 282.

Particularly advantageous are catadioptric projection objectives in which the polarization rotator has at least one retardation element that consists of a calcium fluoride crystal or a barium fluoride crystal or another cubic crystalline material with intrinsic birefringence, the optical axis of the retardation element being aligned approximately in the direction of a <110> crystallographic axis or a main crystal axis equivalent thereto. It is known from the Internet publication entitled “Preliminary determination of an intrinsic birefringence in CaF₂” by John H. Burnett, Eric L. Shirley and Zachary H. Levine, NIST Gaithersburg, Md. 20899, USA (posted on Jul. 5, 2001) that calcium fluoride single crystals exhibit intrinsic birefringence, that is to say birefringence that is not stress-induced. The measurements presented show that a birefringence of (6.5±0.4) nm/cm at a wavelength of λ=156.1 nm occurs for beam propagation in a direction of the <110> crystallographic axis or equivalent directions. The value drops toward higher wavelengths and is (3.6±0.2) nm/cm at 193.09 nm, for example. Measurements by the applicant even exhibit values of approximately 11 nm/cm for λ=157 nm. By contrast, the birefringence in the other crystal directions is small. A corresponding residual birefringence with a maximum in the <110> direction of the crystal is also found for barium fluoride single crystals, being approximately 25 nm/cm at 157 nm, and thus being approximately twice as high by comparison with calcium fluoride single crystals.

The intrinsic birefringence of these materials, which is a maximum for passage of the beam parallel to the crystal directions of type >110>, can be used in a targeted fashion as operating mechanism for retardation elements. Because of the relatively low values of the birefringence (by comparison with magnesium fluoride, for example), such retardation elements can be several millimeters or centimeters thick, the result being to facilitate fabrication and, if appropriate, mounting of such elements. Typical thicknesses can be more than approximately 5 mm, in particular between approximately 10 mm and approximately 50 mm. It is also advantageous that because of the relatively low birefringence slight fluctuations in the thickness of the elements have only a slight influence on the retardation effect. The high tolerance with respect to variations in thickness can be used, for example, to form at least one surface of such a retardation element as a functional surface. For example, it is possible for at least one of the end faces to be curved spherically or aspherically or as a free-form surface, such that the retardation element can also contribute to the correction of an optical system.

One or both boundary surfaces can also have a substantial curvature such that the retardation element can form a lens, preferably in the shape of a meniscus. The retardation element can therefore also have positive or negative refractive power. The integration of the retardation effect occupying the foreground here with a lens action can be used for designs that save material or are of favorable design. Such lenses can also be useful in purely dioptric optical systems, in particular in microlithography projection objectives or illumination systems.

The intrinsic birefringence of the said materials has its maximum value in <110> crystal directions. For beams that run through the material at an angle to <110> directions, the magnitude of the intrinsic birefringence exhibits a parabolically decreasing profile with growing angle, whilst the axes of the intrinsic birefringence approximately retain the direction. This circumstance can be used to smooth out the retardation effect over the entire transirradiated surface. For this purpose, it is possible in the case of a retardation element with two optical surfaces, for the shape of the optical surfaces and the installation position of the retardation element to be adapted to one another in such a way that the light path of beams inside the retardation element is larger between the optical surfaces the larger the angle is between the beam and the optical axis or a <110> direction of the retardation element. Consequently, beams with a greater angle to the <110> direction have to cover a longer light path, and so the retardation effect that results from the product between intrinsic birefringence and light path becomes approximately uniform over the entire active surface.

This concept will be explained later with the aid of exemplary embodiments in the case of which the polarization rotator has a lens or lens group arranged in the vicinity of the concave mirror, made from <110>-oriented fluoride crystal and which is in the shape of a meniscus overall and has a negative refractive power. A lens or lens group of this type arranged in the vicinity of the pupil can have a largely constant or only slightly varying retardation effect over the entire pupil.

The integration described here of a retardation element with a lens element by producing a lens element (provided with refractive power) made from a <110>-oriented single crystal with intrinsic birefringence (for example, calcium fluoride single crystal or barium fluoride single crystal) is advantageously useful not only for catadioptric projection objectives with geometric beam splitting. A suitably dimensioned lens or lens group with the retardation effect of a λ/4 plate can also be used in systems with polarization-selective beam splitter as (functionally necessary) retarder between beam splitter and concave mirror and/or at another point of a projection objective, for example, between object plane and beam splitter and/or between beam splitter and image plane.

The foregoing and further features proceed from the description and the drawings as well as from the claims, the individual features being implemented in each case on their own or several in the form of subcombinations in the case of embodiments of the invention and in other fields, and can constitute advantageous designs which are also capable of protecting themselves.

### BRIEF DESCRIPTION OF THE DRAWINGS

FIG. 1 shows a schematic of a microlithography projection exposure machine that is designed as a wafer stepper and comprises a catadioptric projection objective with geometric beam splitting in accordance with an embodiment of the invention;

FIG. 2 is a schematic that shows the dependence of the reflectivity R of a mirror on the angle of incidence I of the incident radiation for s- and p-polarized light;

FIG. 3 shows a schematic detailed view of the catadioptric objective part of the projection objective shown in FIG. 1;

FIG. 4 shows a schematic of an embodiment of a catadioptric projection objective with geometric beam splitting and a negative meniscus lens that serves as a λ/4 retarder; and

FIG. 5 shows a schematic of the catadioptric objective part of a projection objective with a physical beam splitter.

### DETAILED DESCRIPTION OF PREFERRED EMODIMENTS

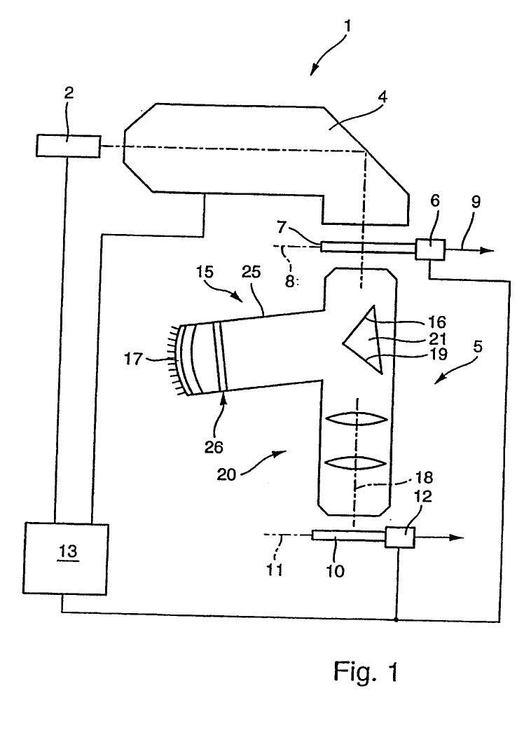

A microlithography projection exposure machine in the form of a wafer stepper 1 that is provided for producing semiconductor components of large-scale integration is shown schematically in FIG. 1. The projection exposure machine comprises as light source an excimer laser 2 which emits ultraviolet light with an operating wavelength of 157 nm and which, in the case of other embodiments, can also lie thereabove, for example at 193 nm or 248 nm, or therebelow. A downstream illuminating system 4 generates a large, sharply delimited and homogeneously illuminated image field which is adapted to the telecentricity requirements of the downstream projection objective 5. The illumination system has devices for selecting the illumination mode and can, for example, be switched between conventional illumination with a variable degree of coherence, angular field illumination and dipole or quadrupole illumination. A device 6 for holding and manipulating a mask 7 is arranged behind the illumination system such that the mask lies in the object plane 8 of the projection objective and, for the purpose of scanner operation, can be moved in this plane in a traversing direction 9 (y-direction) by means of a scan drive.

Following behind the mask plane 8 is the projection objective 5, which acts as reduction objective and images an image of a pattern arranged on the mask at a reduced scale, for example the scale 1:4 or 1:5, onto a wafer 10 which is coated with a photoresist layer and is arranged in the image plane 11 of the reduction objective. Other reduction scales are possible, for example stronger reductions of down to 1:20 or 1:200. The wafer 10 is held by a device 12 which comprises a scanner drive., in order to move the wafer synchronously with the reticle 7 and parallel to the latter. All the systems are controlled by a control unit 13.

The projection objective 5 operates with geometrical beam splitting and has between its objective plane (mask plane 8) and its image plane (wafer plane 11) a catadioptric objective part 15 having a first deflecting mirror 16 and a concave mirror 17, the plane deflecting mirror 16 being tilted to the optical axis 18 of the projection objective in such a way that the radiation coming from the objective plane is deflected by the deflecting mirror 16 in the direction of the concave mirror 17. In addition to this mirror 16 required for the projection objective to function, a second, plane deflecting mirror 19 is provided which is tilted to the optical axis in such a way that the radiation reflected by the concave mirror 17 is deflected by the deflecting mirror 19 in the direction of the image plane 11 to the lenses of the downstream, dioptric objective part 20. The mutually perpendicular, plane mirror surfaces 16, 19 are provided on a beam deflecting device 21 designed as a reflecting prism, and have parallel tilting axes perpendicular to the optical axis 18.

In the example shown, the catadioptric objective part is designed so as to produce in the region of the second deflecting mirror 19 an intermediate image which preferably does not coincide with the mirror plane, but can lie either therebehind or in front thereof in the direction of the concave mirror 17. Embodiments without an intermediate image are also possible. Furthermore, it is possible for the mirrors 16, 19 to be designed as mirrors physically separated from one another.

A particular feature of the objective design consists in that a retardation element 26 in the form of a λ/4 plate is arranged in a region, traversed twice by the light, between the beam deflecting device 21 and the concave mirror 17 in an obliquely positioned side arm 25 of the objective. Said λ/4 plate serves as a polarization rotator that effects a rotation of the preferred polarization direction of the light by 90° in the light path between the first and the second deflecting mirror 16 and 19, respectively. Owing to the oblique position of the side arm, it is possible, inter alia, to ensure a sufficient working distance over the entire width of the objective on the mask side. The angles of incidence of the deflecting mirrors 16, 19, which are situated with their planes perpendicular to one another, can correspondingly deviate by several degrees from 45° with respect to the optical axis 18.

The reflecting surfaces of the deflecting mirrors 16, 19 are coated with highly reflective coatings 23, 24 in order to achieve a high reflection factor. These comprise preferably one or more layers made from dielectric material and whose refractive indices and layer thicknesses are selected so as to produce an amplification of reflection in the range used for the angle of incidence.

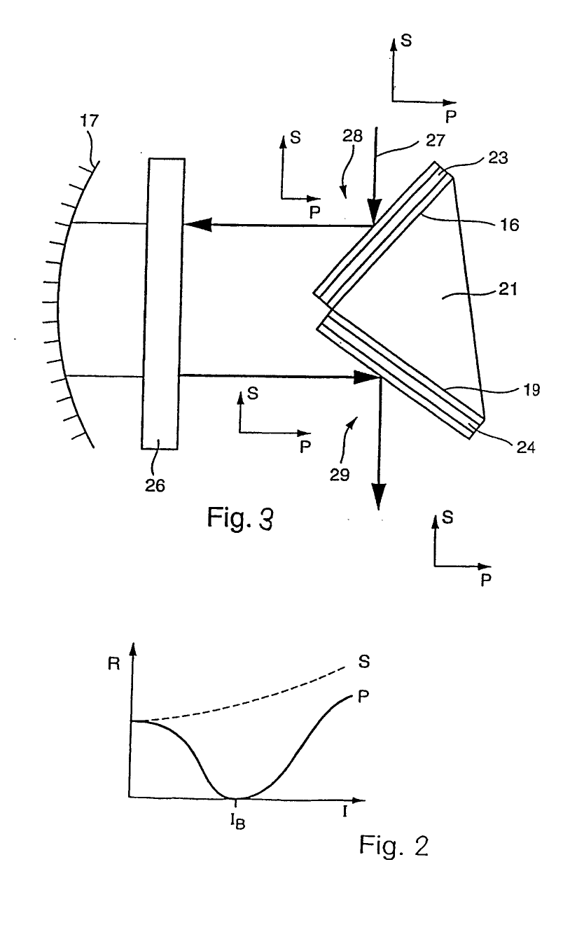

These layers introduce a phase difference, dependent on polarization between the field components, aligned perpendicular to one another, of the electric field vector of the reflected light (s-polarization and p-polarization, respectively). This arises because the layers for s- and p-polarization constitute a different optical path as a function of the angle of incidence of the rays, depending on the angle of incidence. Moreover, conventional multiple layers have different reflection factors for s- and p-polarization. A profile of the reflection factor R that is typical for multiple layers is shown schematically in FIG. 2 as a function of the angle of incidence I. Accordingly, the reflection factors for s- and p-polarization are equal in the case of perpendicular incidence (angle of incidence 0°). With the increasing angle of incidence, the reflection factor for s-polarization increases monotonically, while the reflection factor for p-polarization firstly decreases up to the Brewster angle I_{B}, only to increase again as the angle of incidence rises further. In general, therefore, for conventional reflective layers a reflection factor for s-polarization is greater over the entire angular range than for p-polarization, particularly strong differences in reflectivity resulting in the region of the Brewster angle lying at approximately 45°.

Given the geometric beam splitting shown by way of example, with conventional projection objectives this can lead to the fact that the p-components of the electric field are more strongly attenuated during passage through the objective than the s-component, and so, for example in the case of entrance-side, unpolarized or circularly polarized light, the light striking the image plane has a stronger s-component. Differences in resolution that are dependent on structural direction can thereby occur.

These problems are avoided in the case of the embodiment shown by virtue of the fact that the polarization of the light is rotated by approximately 90° overall with the aid of the polarization rotator 26 between the deflecting mirrors 16, 19. Shown in FIG. 3 by way of explanation is an example in which the input light 27 striking the first deflecting mirror 16 is circularly polarized, the amplitudes, symbolized by the arrow lengths, of s-polarization and p-polarization being substantially equal. After reflection at the obliquely positioned mirror 16, the component, oscillating parallel to the incidence plane, of the electric field is more strongly attenuated than the s-component. This light traverses the retardation element 26, which is designed as a λ/4 plate and retards the phases of the field components by a quarter wavelength relative to one another. After reflection at the concave mirror 17, in the case of which the polarization state remains substantially unaltered, the reflected light passes again through the λ/4-plate, which is thereby traversed twice, a further phase retardation by λ/4 taking place. The double passage through the plate 26 thus leads overall to a λ/2 retardation which corresponds to a rotation of the preferred polarization directions by 90°. As a result of this, the light which is s-polarized with reference to the second deflecting mirror 19 has the (weaker) amplitude of the component which is p-polarized downstream of the first deflecting mirror, while the p-component now has the greater amplitude. On the basis of the differences, explained with the aid of FIG. 3, in reflectivity, this p-component is now more strongly attenuated than the (weaker) s-component, and so a matching of the amplitudes occurs for s- and p-polarization. The multiple layers 23 and 24 are advantageously designed such that substantially the same amplitudes of s- and p-polarization occur downstream of the second deflecting mirror 16. Imaging without contrast differences dependent on structural direction is thereby possible with the aid of this light.

As an alternative to the doubly traversed retardation element 26 with the effect of a λ/4 plate, it is also possible to position a retardation element with λ/2 retardation in a singly traversed light path between a first and second deflecting mirror, for example directly behind the first deflecting mirror at position 28 or directly in front of the second deflecting mirror at position 29. The element can be free standing or combined with another optical element, for example by wringing onto a plane or only slightly curved surface, for example of a lens.

The λ/4 plate or the abovementioned λ/2 plates can consist of birefringent crystalline material such as, for example, magnesium fluoride. Because of the strong birefringence, retardation plates of lowest order are rendered very thin, and this can give rise to difficulties in production engineering and mounting technology. Plates of higher retardation order and correspondingly greater thickness are certainly possible, but exhibit far less angular tolerance, and so the retardation effect varies strongly for different angles of incidence. More favorable, by contrast, are plates made from calcium fluoride or another crystalline material that exhibits stress birefringence owing to the external forces or to the production process (cf. for example, U.S. Pat. No. 6,191,880 or U.S. Pat. No. 6,201,634).

In the case of preferred embodiments, retardation elements that can, in particular, have the function of a λ/4 plate or λ/2 plate are fabricated from a cubic crystalline material with intrinsic birefringence, in particular from a calcium fluoride single crystal or a barium fluoride single crystal, in which a crystallographic axis of type <110> runs substantially in the direction of the optical axis of the retardation element. These materials exhibit intrinsic birefringence which is of maximum magnitude parallel to the <110> directions and is of the order of magnitude of 11 nm/cm (for calcium fluoride) or approximately 25 nm/cm (for barium fluoride) at a wavelength of approximately 157 nm. The corresponding retardation elements can thereby have typical thicknesses of the order of magnitude of several millimeters, in particular of centimeters (for example approximately 36 mm for a λ/4 plate as calcium fluoride) so that they can be effectively fabricated and effectively handled, are self-supporting and, if appropriate, easy to mount.

A plane-parallel plate can be used as retardation element when the angles of incidence are not very large. However, for oblique passage of light the geometric path in the material is longer. This compensates the approximately parabolic attenuation of the intrinsic birefringence upon deviation from the <110> direction up to a certain limit such that only changes of up to approximately 10% from the desired value occur in the retardation effect even for angles of incidence as far as into the region of 15°.

With the aid of FIG. 4, another embodiment of a catadioptric projection objective with a geometric beam splitter will be explained in the case of which a polarization rotator 37 in the form of a twice-penetrated λ/4 retarder is arranged between the beam splitter 35 and the concave mirror 36. This is a lens, arranged in the vicinity of the concave mirror, made from <110>-oriented calcium fluoride crystal that is in the shape of a meniscus overall and has a negative refractive power. The negative lens 37 arranged in the vicinity of the pupil has a dual function. On the one hand, as optical lens it supports together with the concave mirror 36 the chromatic correction of the projection objective. At the same time, it acts as a λ/4 retardation element having a retardation effect that is largely constant over the entire pupil or varies only slightly. It has been recognized that a largely constant distribution of the retardation over the pupil can be achieved whenever the (axial) thickness d of the retardation element is optimized as a function of the radial distance x from the optical axis such that the light path of the beams inside the retardation element between the entry of light and exit of light is larger, the larger the angle αᵢₙ between the beam and the optical axis of the retardation element or the <110>-direction running parallel to said axis. The adaptation is ideally such that the parabolic decrease in the intrinsic birefringence in the event of deviation from the <110>-direction is largely or completely compensated by the increase in thickness.

A bundle of beams 38 at the center of the retardation element 37 is considered in order to detect the ideal curvature in the center region of the retardation element. The condition may be set up for all beams that the optical path length in the material is λ/4. A surface is thereby defined that is in the two-dimensional space by the equations
X=(λ/4·sin(αᵢₙ)/Δn(αᵢₙ) and
Z=d(x)=(λ/4·cos(αᵢₙ)/Δn(αᵢₙ)

Here, Δn is the difference in refractive index between the medium (normally air) surrounding the retardation element and the material of the retardation element, αᵢₙ is the angle between the optical axis or the <110>-axis and the respectively considered beam 38, and d(x) is the thickness as a function of the radius x of the retardation element. This calculation yields a somewhat parabolic profile of the thickness in the radial direction of the retardation element, that is approximately implemented in the case of the negative meniscus lens 37, taking account of the curvatures, ideal for optical reasons, of the entrance face and exit face.

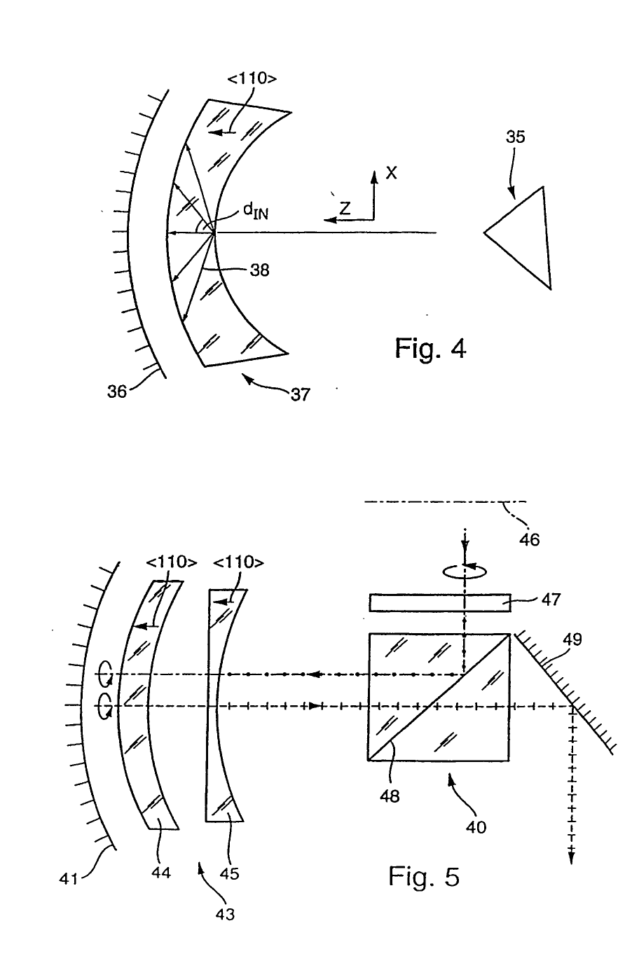

If the resulting lens thickness is regarded as unfavorable, it is also possible to distribute the retardation over a plurality of retardation lenses or combinations of retardation lenses and retardation plates whose overall thickness can be determined, for example, in accordance with the above equations (compare FIG. 5).

In order to be able to obtain optimum use from this aspect of the invention, the combined lenses/retardation element should be arranged in a region with the smallest possible angle of incidence. Ideally, the maximum angle of incidence in air should not be greater than approximately 39°, since otherwise a crystal-lographically induced four-wave character of the retardation as a function of crystal direction can become noticeable. It is likewise favorable when the curvature of the lens is made smaller the smaller the angle αᵢₙ is. The sum of the lens thicknesses should correspond approximately to the corresponding thickness of a λ/4 retardation element consisting of the material. Small corrections of the overall thickness in order to adapt the retardation effect can be advantageous. For example, it can be more favorable when the retardation effect is set more accurately for edge beams than for central beams. This can lead to a homogenization of the intensity distribution after two-fold passage through the retardation element.

The inventive aspect also permits corrective measures for the case wherein the ideal overall thickness determined is too large or too small. For example, it is possible to attenuate the retardation when two <110>-cut lenses of approximately the same thickness are rotated relative to one another by 45° with reference to the <110> axis. If the overall thickness is too small, it is possible, for example, to provide an additional, plane-parallel plate made from <110>-oriented material. It is to be ensured here, in particular, that the inclination of the beams is not too large.

An embodiment of a catadioptric projection objective with a polarization-selective beam splitter 40 in the form of a beam splitter cube is explained with the aid of FIG. 5. In this embodiment, a polarization rotator 43 acting as a λ/4 retarder is arranged between the beam splitter 40 and the concave mirror 41. The polarization rotator comprises two negative meniscus lenses 44, 45 that consist in each case of <110>-oriented calcium fluoride crystal. The overall axial thickness of the lenses corresponds in the central region close to the axis to the corresponding thickness of a λ/4 retardation plate (for example, approximately 36 mm for calcium fluoride given an operating wavelength of 157 nm), and increases parabolically in the radial direction in order to smooth out the retardation effect over the entire lens cross section of the lenses 44, 45 arranged in the region of the pupil.

The projection objective is designed for operating with a circularly polarized input light, and has between the object plane 46 and beam splitter 40 a λ/4 plate 47 for converting the input light into a light that is s-polarized with reference to the beam splitter surface 48. This light penetrates the two lenses 44, 45 and is converted because of the retardation effect thereof, into circularly polarized light that is reflected by the concave mirror 41 and runs back through the retardation device 43. After renewed passage through the retardation lenses 44, 45, the light is p-polarized with reference to the beam splitter layer 48, and penetrates the latter without loss in the direction of a deflecting mirror 49 that deflects the light in the direction of the object plane. This explains, for example, that the λ/4 retarder, which is functionally necessary with such systems, between the beam deflection device 40 and concave mirror can be formed by one or more lenses with a suitable retardation effect. The λ/4 plate conventionally required between beam splitter and concave mirror can therefore be eliminated.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

1. A catadioptric projection objective for projecting a pattern arranged in an object plane of the projection objective into the image plane of the projection objective, wherein there are arranged between the object plane and the image plane a catadioptric objective part with a concave mirror and a fully reflecting first deflecting mirror, as well as at least a second fully reflecting deflecting mirror, and wherein a polarization rotator for rotating a preferred polarization direction of light passing through is arranged between the first deflecting mirror and the second deflecting mirror in order to compensate polarization-dependent differences in at least one of reflectivity and phase of the deflecting mirrors.

2. The projection objective as claimed in claim 1, wherein the polarization rotator is designed for rotating the preferred polarization direction by approximately 90° between the deflecting mirrors.

3. The projection objective as claimed in claim 1, which has a region traversed twice by the light between the first deflecting mirror and the second deflecting mirror, wherein the polarization rotator is a retardation device that is arranged in the region traversed twice and has at least approximately the effect of a λ/4 plate.

4. The projection objective as claimed in claim 1, wherein the polarization rotator is arranged in a region of low divergence of the radiation passing through in a near zone of a pupil plane of the projection objective.

5. The projection objective as claimed in claim 1, wherein the polarization rotator is arranged in the vicinity of the concave mirror.

6. The projection objective as claimed in claim 1, wherein the polarization rotator is a retardation device that has at least approximately the effect of a λ/2 plate, and that is arranged in a region, traversed by light only once, between the first deflecting mirror and the second deflecting mirror.

7. The projection objective as claimed in claim 1, wherein the polarization rotator has at least one retardation element that consists of a cubic crystalline material with intrinsic birefringence, the optical axis of the retardation element being aligned approximately in the direction of a <110> crystallographic axis of the crystalline material.

8. The projection objective as claimed in claim 7, wherein the crystalline material is a calcium fluoride crystal or a barium fluoride crystal.

9. The projection objective as claimed in claim 7, wherein the retardation element has a thickness of at least 5 mm.

10. The projection objective according to claim 9, wherein the retardation element has a thickness between approximately 10 mm and approximately 50 mm.

11. The projection objective as claimed in claim 7, wherein at least one retardation element is designed as a lens element of positive or negative refractive power.

12. The projection objective as claimed in claim 11, wherein the lens is a meniscus lens.

13. The projection objective as claimed in claim 12, wherein the meniscus lens has negative refractive power.

14. The projection objective as claimed in claim 7, wherein at least one retardation element has two optical surfaces, the shape of the optical surfaces and the mounting position of the retardation element being adapted to one another in such a way that the light path of beams inside the retardation element between the optical surfaces becomes larger the larger the angle between a beam passing through and the optical axis of the retardation element.

15. The projection objective as claimed in claim 7, wherein the polarization rotator has at least one lens made of a cubic crystalline material with intrinsic birefringence for which the thickness as a function of the radius has an approximately parabolic profile with radially increasing thickness.

16. The projection objective as claimed in claim 7, wherein the polarization rotator has at least one lens that consists of a cubic crystalline material with intrinsic birefringence, that is arranged in the vicinity of a pupil plane of the projection objective.

17. The projection objective according to claim 16, wherein the lens is arranged in the vicinity of the concave mirror.

18. The projection objective according to claim 16, wherein the lens has negative refractive power.

19. A catadioptric projection objective for projecting a pattern arranged in an object plane of the projection objective into the image plane of the projection objective, in which there are arranged between the object plane and the image plane a catadioptric objective part with a concave mirror and a polarization-selective beam splitter with a beam splitter surface, wherein arranged between the beam splitter surface and the concave mirror is a polarization rotator having the effect of a λ/4 plate, and wherein the polarization rotator has at least one retardation element that is designed as a lens and consists of a cubic crystalline material having an intrinsic birefringence, an optical axis of the retardation element being aligned approximately in the direction of a <110>crystallographic axis of the crystalline material.

20. The catadioptric projection objective according to claim 19, wherein the crystalline material is a calcium fluoride crystal or barium fluoride crystal.

21. The projection objective as claimed in claim 19, wherein at least one retardation element is designed as a meniscus lens.

22. The projection objective according to claim 21, wherein the meniscus lens has negative refractive power.

23. The projection objective as claimed in claim 19, wherein at least one retardation element has two optical surfaces, the shape of the optical surfaces and the mounting position of the retardation element being adapted to one another in such a way that the light path of beams inside the retardation element between the optical surfaces becomes larger the larger the angle between a beam passing through and the optical axis of the retardation element.

24. The projection objective as claimed in claim 23, wherein in the case of the retardation element the total thickness as a function of the radius has an approximately parabolic profile with radially increasing thickness.

25. The projection objective as claimed in claim 19, wherein the polarization rotator is arranged in the vicinity of a pupil plane of the projection objective.

26. The projection objective as claimed in claim 19, wherein the polarization rotator is arranged in the vicinity of the concave mirror.

27. The projection objective as claimed in claim 19, wherein no λ/4 plate is arranged between the beam splitter surface and the concave mirror.

28. An optical system, which has at least one retardation element that is designed as a lens and consists of a cubic crystalline material having an intrinsic birefringence, an optical axis of the retardation element being aligned approximately in the direction of a <110>crystallographic axis of the crystalline material.

29. The optical system as claimed in claim 28, wherein the crystalline material is a calcium fluoride crystal or a barium fluoride crystal.

30. The optical system as claimed in claim 28, wherein the retardation element is a meniscus lens.

31. The optical system as claimed in claim 30, wherein the meniscus lens has negative refractive power.

32. The optical system as claimed in claim 28, wherein the thickness of the retardation element as a function of the radius has an approximately parabolic profile with radially increasing thickness.

33. The optical system as claimed in claim 28, wherein the optical system is a projection objective for microlithography.
